(19) United States
(12) Patent Application Publication
(10) Pub. No.: US 2026/0167041 A1
(43) Pub. Date: Jun. 18, 2026

(54) ELECTRIC VEHICLE CHARGING/DISCHARGING SCHEDULING APPARATUS AND METHOD

(71) Applicants: HYUNDAI MOTOR COMPANY, Seoul (KR); KIA CORPORATION, Seoul (KR)

(72) Inventors: Hye Seung Han, Hwaseong-si (KR); Hyun Sup Kim, Hwaseong-si (KR); Min Kyu Lee, Hwaseong-si (KR); Jae Yun Jung, Hwaseong-si (KR); Bum Su Park, Hwaseong-si (KR); Na Yeon Park, Hwaseong-si (KR); Dae Gun Ko, Hwaseong-si (KR); Sung Kyu Kim, Hwaseong-si (KR); Jeong Hoon Choi, Hwaseong-si (KR)

(73) Assignees: HYUNDAI MOTOR COMPANY, Seoul (KR); KIA CORPORATION, Seoul (KR)

(21) Appl. No.: 19/203,944

(22) Filed: May 9, 2025

(30) Foreign Application Priority Data
Dec. 13, 2024 (KR) 10-2024-0185996

(51) Int. Cl. B60L 53/62; B60L 53/64

(52) U.S. Cl. CPC B60L 53/62; B60L 53/64

(57) ABSTRACT

An electric vehicle charging/discharging scheduling apparatus is provided. The apparatus includes one or more processors, and a memory configured to store one or more programs executed by the one or more processors. The processor calculates a first charging/discharging schedule so that a state of charge (SoC) at a time of the electric vehicle exiting is equal to or higher than a target SoC according to electric vehicle information, calculates a second charging/discharging schedule for participation in a power market according to contracted power capacity data received from a demand management business operator server based on the first charging/discharging schedule, and adjusts the second charging/discharging schedule to reflect the battery deterioration cost of the electric vehicle.

### CROSS-REFERENCE TO RELATED APPLICATION(S)

This application claims benefit of priority to Korean Patent Application No. 10-2024-0185996 filed on Dec. 13, 2024, in the Korean Intellectual Property Office, the disclosure of which is incorporated herein by reference in its entirety.

### TECHNICAL FIELD

The present disclosure relates to an electric vehicle charging/discharging scheduling apparatus and method.

### BACKGROUND

At the same time that the spread of various dispersion energy sources such as solar power generation, wind power generation, and ESSs is receiving attention, vehicle to grid (V2G) technology, which enables the energy of electric vehicle batteries to be sent to a power system and discharged, in addition to charging, is also receiving attention. It may be useful to have research on technologies that utilize V2G technology to reduce electricity rates and generate profits by linking with homes (V2H), buildings (V2B), and the like, and further contribute to stabilizing the power system.

Managing electric vehicle charging/discharging scheduling is becoming an important issue. Recently, as the spread and sale of electric vehicles increase, charging/discharging variables are increasing, which has led to problems such as increased computational dimensions, increased complexity, and, most notably, an increase in required time.

### SUMMARY

The present disclosure is directed to providing an electric vehicle charging/discharging (e.g., charging and discharging) scheduling apparatus and method capable of performing (e.g., optimal) charging/discharging scheduling of an electric vehicle.

The present disclosure is also directed to providing an electric vehicle charging/discharging scheduling apparatus and method capable of minimizing the battery deterioration costs of an electric vehicle and extending the life of the battery.

The present disclosure is also directed to providing an electric vehicle charging/discharging scheduling apparatus and method capable of generating profits by participating in a power trading market using the power of an electric vehicle.

According to an aspect of the present disclosure, there is provided an electric vehicle charging/discharging scheduling apparatus, including one or more processors, and a memory configured to store one or more programs executed by the one or more processors. The processor calculates a first charging/discharging schedule so that a state of charge (SoC) at a time of the electric vehicle exiting is equal to or higher than a target SoC according to electric vehicle information, calculates a second charging/discharging schedule for participation in a power market according to contracted power capacity data received from a demand management business operator server based on the first charging/discharging schedule, and adjusts the second charging/discharging schedule to reflect the battery deterioration cost of the electric vehicle.

The processor may adjust the second charging/discharging schedule so that the battery deterioration cost of the electric vehicle is minimized.

The processor may adjust the second charging/discharging schedule so that continuity of charging/discharging actions is maintained in successive first and second charging/discharging commands.

The processor may calculate a weight according to the types of charging/discharging actions in the first charging/discharging command and the second charging/discharging command, and may adjust the second charging/discharging schedule according to the weight.

The processor may adjust the second charging/discharging schedule by reflecting a first inverse weight when the charging/discharging actions in the first charging/discharging command and the second charging/discharging command are different.

The processor may adjust the second charging/discharging schedule by reflecting a second inverse weight that is smaller than the first inverse weight when at least one of the first charging/discharging command and the second charging/discharging command is a standby command.

The processor may adjust the second charging/discharging schedule by reflecting a weight when the charging/discharging actions in the first charging/discharging command and the second charging/discharging command are the same.

The weight may have different weight scales for each time slot.

The processor may set the weight scale using the target SoC and the contracted power capacity data.

The processor may set the weight scale for each time slot according to at least one of the cost of selling power for each time slot, the cost of purchasing power, and a charging rate system of the electric vehicle.

According to an embodiment, there is provided an electric vehicle charging/discharging scheduling method, which is performed by a computing device including one or more processors and a memory configured to store one or more programs executed by the one or more processors, the method including calculating, by the processor, a first charging/discharging schedule so that a SoC at a time of the electric vehicle exiting is equal to or higher than a target SoC according to electric vehicle information, calculating, by the processor, a second charging/discharging schedule for participation in a power market according to contracted power capacity data received from a demand management business operator server based on the first charging/discharging schedule, and adjusting, by the processor, the second charging/discharging schedule to reflect the battery deterioration cost of the electric vehicle.

The adjusting of the second charging/discharging schedule may include adjusting the second charging/discharging schedule so that the battery deterioration cost of the electric vehicle is minimized.

The adjusting of the second charging/discharging schedule may include adjusting the second charging/discharging schedule so that continuity of charging/discharging actions is maintained in successive first and second charging/discharging commands.

The adjusting of the second charging/discharging schedule may include calculating a weight according to the types of charging/discharging actions in the first charging/discharging command and the second charging/discharging command, and adjusting the second charging/discharging schedule according to the weight.

The adjusting of the second charging/discharging schedule may include adjusting the second charging/discharging schedule by reflecting a first inverse weight when the charging/discharging actions in the first charging/discharging command and the second charging/discharging command are different.

The adjusting of the second charging/discharging schedule may include adjusting the second charging/discharging schedule by reflecting a second inverse weight that is smaller than the first inverse weight when at least one of the first charging/discharging command and the second charging/discharging command is a standby command.

The adjusting of the second charging/discharging schedule may include adjusting the second charging/discharging schedule by reflecting a weight when the charging/discharging actions in the first charging/discharging command and the second charging/discharging command are the same.

The weight may have different weight scales for each time slot.

The adjusting of the second charging/discharging schedule may further include setting the weight scale using the target SoC and the contracted power capacity data.

The setting of the weight scale may include setting the weight scale according to at least one of the cost of selling power for each time slot, the cost of purchasing power, and a charging rate system of the electric vehicle.

### BRIEF DESCRIPTION OF THE DRAWINGS

The above and other objects and features of the present disclosure will become more apparent to those of ordinary skill in the art by describing exemplary embodiments thereof in detail with reference to the accompanying drawings.

FIG. 1 is a view for describing an electric vehicle power management system according to an embodiment.

FIG. 2 is a block diagram of an electric vehicle charging/discharging scheduling apparatus according to an embodiment.

FIG. 3 is a view for describing the operation of a processor according to an embodiment.

FIGS. 4, 5, 6, and 7 are views for describing the operation of a fourth processing unit according to an embodiment.

FIG. 8 is a flowchart of an electric vehicle charging/discharging scheduling method according to an embodiment.

### DETAILED DESCRIPTION

Exemplary embodiments of the present disclosure will be described in detail below with reference to the accompanying drawings.

However, the technical idea of the present disclosure is not limited to some of the embodiments described, but may be implemented in various different forms, and within the scope of the technical idea of the present disclosure, one or more of the components among the embodiments may be selectively combined or substituted and used.

In addition, the terms (including technical and scientific terms) used in the embodiments of the present disclosure may be interpreted as having meanings that are generally understood by a person of ordinary skill in the technical field to which the present disclosure belongs, unless provided and described, and commonly used terms such as terms defined in dictionaries may be interpreted in consideration of their contextual meaning in the art.

Additionally, the terms used in the embodiments of the present disclosure are for the purpose of describing the embodiments and are not intended to limit the present disclosure.

In this specification, the singular may also include the plural unless the context clearly dictates otherwise, and when described as “at least one (or one or more) of A, B, and C,” it may include one or more of all possible combinations of A, B, and C.

Additionally, in describing components of embodiments of the present disclosure, terms such as first, second, A, B, (a), (b), or the like may be used.

These terms are intended to distinguish one component from another, and are not intended to limit the nature, order, or sequence of the component.

In addition, when a component is described as being “connected,” “coupled,” or “linked” to another component, it may include cases in which the component is directly connected, coupled, or linked to the other component, and also cases in which the component is “connected,” “coupled,” or “linked” by another component between the component and the other component.

Additionally, when a component is described as being formed or disposed on “on (above) or below (under)” another component, “above” or “below” includes cases in which the two components are in direct contact with each other, and also cases in which one or more other components are formed or disposed between the two components. Additionally, when expressed as “above or below,” it may include the meaning of the upward direction and also the downward direction based on one component.

Hereinafter, embodiments will be described in detail with reference to the attached drawings. Regardless of the drawing numbers, identical or corresponding components are given the same reference numerals, and redundant descriptions thereof may be omitted.

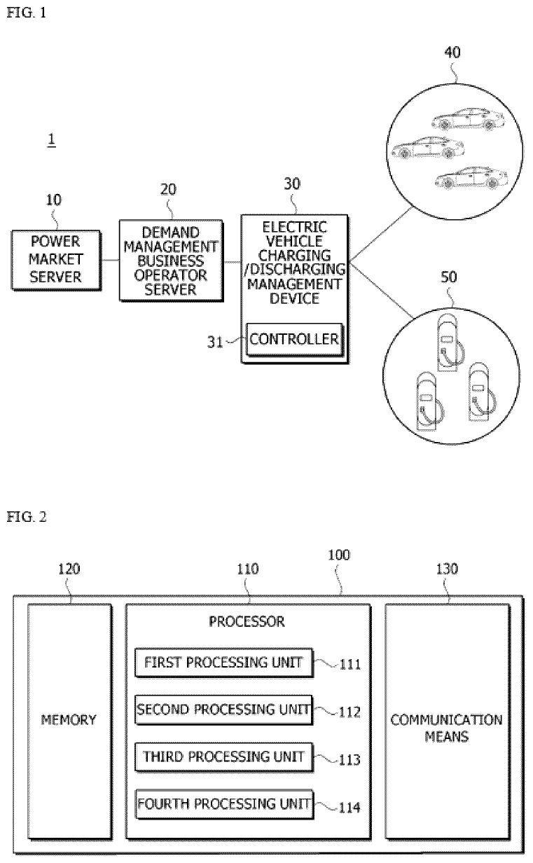

FIG. 1 is a view of an electric vehicle power management system according to an embodiment. Referring to FIG. 1, the electric vehicle power management system 1 may include a power market server 10, a demand management business operator server 20, and an electric vehicle charging/discharging management device 30.

The power market server 10 is an entity that operates a power market and may perform settlement according to a participation amount for each source in different ways according to market settlement rules. The power market server 10 may mediate power transactions between demand management business operator servers 20 using power transaction request information received from a plurality of demand management business operator servers 20.

The power market server 10 may be a server that contracts with a demand management business operator for an amount of power usage and an amount of discharge business and distributes profits to the demand management business operator through demand response and a time-based power unit price.

The demand management business operator server 20 may perform power transactions using charging/discharging information received from the linked electric vehicle charging/discharging management device 30, renewable energy generation amount information of a linked renewable energy generation system, and power demand information of a linked system.

In an example embodiment, the demand management business operator may refer to a business operator who contracts with places that use large amounts of power, such as factories, large buildings and parking towers, to reduce power consumption according to demand response, and thus gains profits.

A power system linked to the demand management business operator may transmit power demand information to the demand management business operator server 20 at a preset cycle, at the request of the demand management business operator server, or when necessary. The power demand information may include an amount of hourly power demand and power usage reduction demand for the linked system.

The demand management business operator server 20 may respond to demand response through a request to reduce the amount of power usage, and also perform a role similar to a power plant that transmits power that may be used directly in the grid using electric vehicles 40, electric vehicle batteries, ESSs, or the like.

For example, the demand management business operator server 20 may receive the next day's charging/discharging amount of the electric vehicle charging/discharging management device 30 at a specific time every day and bidding may be made on the power market server side, and the contracted amount may be received from the power market server 10 according to a preset cycle and transmitted to the electric vehicle charging/discharging management device 30.

The electric vehicle charging/discharging management device 30 (e.g., directly) manages electric vehicles 40 and charging stations 50 of customers participating in a V2X service, and may receive information on the electric vehicles 40 and chargers, plug-in/out signals, and the like. The electric vehicle charging/discharging management device 30 may determine the next day's charging/discharging bid amount with the goal of maximizing market participation profits, and may control the charging/discharging of the individual electric vehicles 40 to fulfill the contracted amount.

The electric vehicle charging/discharging management device 30 may monitor information on the electric vehicles 40 and charging stations 50 and may provide various types of data for customers. The electric vehicle charging/discharging management device 30 may perform functions such as billing settlement, parking space management, generation and transmission of charging/discharging control commands, charging/discharging scenario control, and vehicle battery status diagnosis.

The electric vehicle charging/discharging management device 30 may include a controller 31.

The power system may include smart grid-related systems such as, for example, a substation, a power market server, a demand management business operator server, renewable sources, or an energy storage system (ESS). The renewable sources may be wind, solar, geothermal, or waste-based energy sources. The power system may supply power within a range of allowable power (or maximum power (Pmax) or allowable AC current (IACmax)) to the charging stations 50 under the control of the controller 31.

In some cases, when a large number of electric vehicles 40 are concentrated at charging stations 50 in a specific region at the same time, the maximum allowable power of the power system may vary. That is, the power market server 10 that controls a system operation, the demand management business operator server 20 or an energy management system (EMS) may deploy a reserve power source such as an energy storage system (ESS) or may deploy a surrounding renewable energy source to increase a power capacity and supply the power to the charging stations.

The allowable power may be increased by the control of the controller 31 when the power supplied to the electric vehicles 40 is insufficient due to charging demand information of each electric vehicle 40 (e.g., a charging demand amount of electric vehicle users). That is, the controller 31 may control a switch to additionally connect (e.g., deploy) a renewable energy source (or the energy storage system (ESS)) within the power system to the substation that supplies power to the charging stations 50 so that the allowable power of the power system increases when a charging load (e.g., a load of the electric vehicle) of the charging station 50 exceeds the allowable power of the power system.

The controller 31 may control the overall operation of components included in the electric vehicle charging/discharging management device 30. The controller 31 is an aggregator and may collect information on a battery capacity of the electric vehicle 40 connected to the charging station 50 through a wired or wireless communication network, a state of charge (SoC) of the battery of the electric vehicle 40, a rated current flowing through a power line, a rated voltage applied to the power line, or charging request information of an electric vehicle user (e.g., an owner). The charging request information of the electric vehicle user may be transmitted to the controller 31 through a communication means included in each of the charging stations 50 or through a communication means such as a mobile phone of the user.

The controller 31 may exchange information with the power system through a wired or wireless communication network, and may exchange data with the charging station 50 through a LAN connection such as Ethernet, power line communication (PLC), or Wi-Fi, which is a wired or wireless communication network.

The controller 31 may control the power of the power system to be supplied to the charging station 50 within an allowable power range of the power system based on real-time information of the power system, status information of the electric vehicles 40, and charging demand information of each electric vehicle 40.

The real-time information of the power system may include the allowable power information of the power system or the electricity rate information of the power system, the status information of the electric vehicle 40 may include the SoC information of the battery included in each electric vehicle 40, and the charging demand information may include a charging demand time of the electric vehicle user, an expected vehicle entry time, an expected vehicle exit time, and a charging demand amount (e.g., a target SoC).

Each of the charging stations 50 may charge the batteries of a plurality of electric vehicles 40. Each of the charging stations 50 may include an AC current limiter that performs a current allocation operation for each of the electric vehicles 40. Additionally, each of the charging stations 50 may include a control module that exchanges information with the battery management system (BMS) of the electric vehicle 40 and the controller 31. Due to the control of the controller 31, the control module may control the current limiter (e.g., the AC current limiter) to provide a DC charging current to each of the batteries of the electric vehicles 40.

Each of the electric vehicles 40 may include a battery management system (BMS). The battery management system may control a battery charging process. Each of the electric vehicles 40 may function as an active load that requests power from the electric vehicle charging/discharging management device 30 during a charging time.

A charger that converts an alternating current of the power system into direct current to charge the battery of the electric vehicle 40 may be an on-board charger included in each electric vehicle 40 or an off-board charger included in each charging station 50.

The electric vehicles 40 may participate in power transactions by registering on a V2X platform. The users of the electric vehicles 40 may join the platform according to the power market they wish to participate in and may register their expected vehicle entry and exit schedules for the next day. The electric vehicles 40 may transmit information such as an expected plug-in time, an expected plug-out time, SoC information, and available battery capacity to the electric vehicle charging/discharging management device 30.

The electric vehicle power management system 1 described above is a centralized control system that may adjust the charging/discharging schedule of electric vehicles by considering hourly power prices or demand and supply of the power system. However, as the number of electric vehicles to be controlled increases, computational burden and complexity for optimal scheduling may increase.

The electric vehicle charging/discharging scheduling apparatus according to an example embodiment may be able to optimize the charging/discharging of a large-scale electric vehicle fleet. The electric vehicle charging/discharging scheduling apparatus according to an example embodiment may be included in a configuration of the electric vehicle charging/discharging management device or may be provided as a separate device. When the electric vehicle charging/discharging scheduling apparatus is provided as a separate device, a separate wired or wireless communication means may be provided for communicating with the electric vehicle, an external server, a terminal, or the like.

An example in which the electric vehicle charging/discharging scheduling apparatus is included and configured in the electric vehicle charging/discharging management device 30 of FIG. 1 is described.

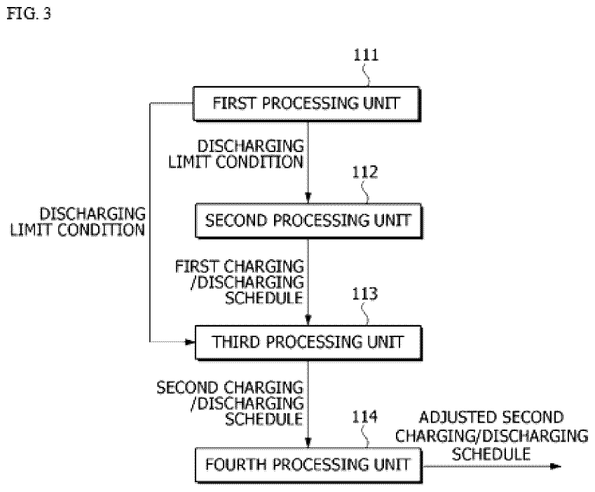

FIG. 2 is a block diagram of the electric vehicle charging/discharging scheduling apparatus according to an embodiment and FIG. 3 is a view for describing the operation of a processor according to an embodiment.

Referring to FIG. 2 and FIG. 3, the electric vehicle charging/discharging scheduling apparatus 100 may include a processor 110, a memory 120, and a communication means 130. In addition, the processor 110 according to the example embodiment may include a first processing unit 111, a second processing unit 112, a third processing unit 113, and a fourth processing unit 114.

The electric vehicle charging/discharging scheduling apparatus 100 according to the example embodiment may be implemented in a logic circuit by hardware, firmware, software or a combination thereof, and may also be implemented using a general-purpose or special-purpose computer. The apparatus may be implemented using hardwired devices, field programmable gate arrays (FPGAs), application specific integrated circuits (ASICs), or the like. Additionally, the electric vehicle charging/discharging scheduling apparatus 100 may be implemented as a system on chip (SoC) including one or more processors and controllers.

In addition, the electric vehicle charging/discharging scheduling apparatus 100 may be installed in a computing device or server equipped with hardware elements in the form of software, hardware, or a combination thereof. The computing device or server may refer to various devices including all or part of a communication device such as a communication modem for communicating with various devices or wired/wireless communication networks, a memory for storing data for executing a program, a microprocessor for executing a program to perform calculations and instructions, and the like.

The memory 120 may include a database (DB). The memory 120 may be a non-transitory storage medium that stores instructions executed by the processor. The memory 120 may include at least one of storage media such as a random access memory (RAM), a static random access memory (SRAM), a read only memory (ROM), a programmable read only memory (PROM), an electrically erasable and programmable ROM (EEPROM), an erasable and programmable ROM (EPROM), a hard disk drive (HDD), a solid state disk (SSD), an embedded multimedia card (eMMC), a universal flash storage (UFS), and/or a web storage.

In the example embodiment, the first processing unit 111 to the fourth processing unit 114 may be implemented through the same process, and for convenience of description, the operation of each component are described separately below.

The processor 110 may include at least one processing device such as an application specific integrated circuit (ASIC), a digital signal processor (DSP), a programmable logic device (PLD), a field programmable gate array (FPGA), a central processing unit (CPU), a microcontroller, and/or a microprocessor.

Additionally, each function of the processor may be implemented and operated by a module, and the operation thereof may be determined by turning each module on/off according to a user's settings.

In the example embodiment, the electric vehicle charging/discharging scheduling apparatus 100 may receive electric vehicle information through a communication means and store it in a database. The electric vehicle information may include plug-in charger information, present SoC, target SoC, source type information, battery capacity information, and battery charging/discharging efficiency, expected vehicle entry time and expected vehicle exit time information.

The first processing unit 111 may calculate a first charging/discharging schedule and a second charging/discharging schedule to limit discharging according to the source type information. The first processing unit 111 may partially limit a charging/discharging function of the electric vehicle using the source type information of the electric vehicle information. For example, the first processing unit 111 may calculate the first charging/discharging schedule and the second charging/discharging schedule so that discharging is limited in the case of an electric vehicle whose source type information is V1G. In addition, the first processing unit 111 may calculate the first charging/discharging schedule and the second charging/discharging schedule so that the electric vehicle may perform both the charging/discharging functions when the source type information is V2G.

In addition, the first processing unit 111 may calculate the first charging/discharging schedule and the second charging/discharging schedule so that the discharging of the electric vehicle is not performed according to the battery charging/discharging efficiency when the discharging efficiency is lower than the standard efficiency.

The first processing unit 111 may set a charging/discharging function limitation and may transmit the function limitation to the second processing unit 112 and the third processing unit 113 so that the function limitation may be reflected in the generation of the first charging/discharging schedule and the second charging/discharging schedule.

The second processing unit 112 may calculate the first charging/discharging schedule so that the SoC at the time of electric vehicle exiting is higher than the target SoC based on the electric vehicle information. The second processing unit 112 may calculate the first charging/discharging schedule using the present SoC of the electric vehicle, the battery capacity information, and the target SoC.

The first charging/discharging schedule may include a first charging power capacity and a first discharging power capacity.

At this time, the second processing unit 112 may set the first charging/discharging schedule by adjusting the SoC of the electric vehicle within a preset battery usage range. When attempting to participate in a V2X service within a range narrower than the basic upper and lower limits of a battery charging amount, this is intended to provide that maximum optimization is performed within that range, thereby preventing errors from occurring in an optimization algorithm even when a SoC value outside the V2X available range is input or derived.

The second processing unit 112 may calculate maximum hourly charging/discharging energy using an output power capacity included in the plug-in charger information, and the expected vehicle entry time and the expected vehicle exit time. The second processing unit 112 may calculate the maximum hourly charging/discharging energy based on an output power value per hour of the charger, but in proportion to the time that the electric vehicle remains in a plugged-in state. For example, when the maximum output per hour of the charger is 10[kW] and the plug-in time of the electric vehicle is from 10:20 to 15:00, the second processing unit 112 calculates the maximum charging/discharging energy in the first time slot (10:00 to 11:00) as 40 [minutes]/60 [minutes]*10 [kW]=6.67 [kWh], and the maximum charging/discharging energy from 11:00 to 15:00 is calculated as 10 [kW].

The second processing unit 112 may set the first charging/discharging schedule so that the SoC at the expected exit time of the electric vehicle may follow the target SoC according to the maximum hourly charging/discharging energy. The second processing unit 112 may set the first charging/discharging schedule so that the SoC at the expected exit time of the electric vehicle may follow the target SoC by applying the battery charging/discharging efficiency.

The first charging/discharging schedule may include an amount of the charging power capacity and an amount of the discharging power capacity of each electric vehicle. At this time, the second processing unit 112 may determine the amount of the charging/discharging power capacity of each of the electric vehicles to follow the target SoC of each of the electric vehicles. The second processing unit 112 may set the first charging/discharging schedule so that a difference value between the SoC of the electric vehicle and the target SoC becomes a minimum value after actual charging or discharging according to the first charging/discharging schedule. At this time, the second processing unit 112 may set a SoC upper limit and a SoC lower limit according to an available capacity range of the battery of each electric vehicle, and may set the first charging/discharging schedule so that the electric vehicle may be charged and discharged within the range of the SoC upper limit and the SoC lower limit.

That is, the second processing unit 112 sets a difference value between the SoC of the electric vehicle after the charging/discharging control and the target SoC as an objective function, and may minimize the difference value through an optimization process of the set objective function. The second processing unit 112 may perform optimization of the objective function by applying a gradient descent method, a steepest descent method, or a stochastic gradient descent method.

The first charging/discharging schedule allows a user using the V2X platform to follow a desired vehicle exit SoC input by the user, and may identify the energy required for charging based on the SoC at the time of vehicle entry, the target SoC, and the battery capacity information of the electric vehicle.

The third processing unit 113 may calculate a second charging/discharging schedule for participation in the power market according to contracted power capacity (CPC) data received from the demand management business operator server based on the first charging/discharging schedule. The third processing unit 113 may calculate the second charging/discharging schedule of the electric vehicle in a case in which there is the contracted power capacity. The third processing unit 113 may calculate the second charging/discharging schedule to comply with the contracted power capacity by time slot. The second charging/discharging schedule may include a second charge power and a second discharge power. Here, the contracted power capacity may be determined according to the previous day's bid power capacity, and as described below, the third processing unit 113 may determine the bid power with a goal of maximizing profits by selling power when the power price is high and purchasing power when the power price is low using a system marginal price (SMP) predictive value.

The third processing unit 113 performs a function of calculating the second charging/discharging schedule when the contracted power capacity is received based on results of bidding in a renewable energy bidding market. The contracted power capacity may include a charging contracted power capacity and a discharging contracted power capacity. The third processing unit 113 may calculate the charging power capacity and the discharging power capacity so that the corresponding contracted power capacity may be (e.g., fully) satisfied in a time slot when there is the contracted power capacity. At this time, the third processing unit 113 may calculate the charging power capacity and the discharging power capacity under a condition that the SoC of the electric vehicle follows the target SoC at the expected vehicle exit time. That is, the third processing unit 113 calculates the charging power capacity and discharging power capacity of the electric vehicle according to the contracted power capacity, but if the target SoC cannot be followed at the expected vehicle exit time when the calculated charging/discharging power capacity is applied, the amount of the calculated charging/discharging power capacity may be adjusted to follow the contracted power capacity.

That is, when the condition that the second charging power capacity and the second discharging power capacity for the target SoC is not satisfied, the third processing unit 113 may modify or discard the second charging/discharging schedule to adjust the second charging power capacity and the second discharging power capacity.

The third processing unit 113 may calculate the second charging/discharging schedule so that the sum of the charging efficiency and the sum of the discharging efficiency are the same. The third processing unit 113 may change the parameters according to the power market rules. The third processing unit 113 may induce the sum of the charging bid power capacities and the sum of the discharging bid power capacities derived during a bidding time (e.g., 00:00 to 24:00 of the next day) in the renewable energy bidding market to be balanced. At this time, the third processing unit 113 may bid in consideration of the charging/discharging efficiency to prevent a loss in the battery charging amounts of participating users. That is, the third processing unit 113 may calculate the second charging/discharging schedule so that the product of the second charging power capacity and the charging efficiency is equal to the product of the second discharging power capacity and the discharging efficiency. Thus, it is possible to effectively prevent SoC loss of an electric vehicle that performs the charging/discharging according to the second charging/discharging schedule.

The battery charging/discharging efficiency of the electric vehicle may be determined by several factors including battery composition, charging speed, control elements of the battery management system, cables, and energy losses generated in electrical components such as power converters. The charging/discharging efficiency refers to a percentage of energy loss during a process of storing electrical energy in a battery, and this loss may occur mainly in the form of heat loss.

The third processing unit 113 may generate charging/discharging schedule information that maximizes profits based on the objective function when a charging/discharging scheduling request is made. The third processing unit 113 may set the charging/discharging schedule so that profits through the sum of a charging fee and a discharging profit is maximized.

The third processing unit 113 may calculate the second charging/discharging schedule using the system marginal price (SMP).

The system marginal price may refer to an index that determines the price of power (e.g., finally) supplied at a specific time slot in the power market. The third processing unit 113 may determine the system marginal price using a power demand predictive value and a bid power capacity of a power plant.

The third processing unit 113 sorts the bid power capacities from power plants that have proposed an amount and price of power to be supplied at a specific time slot in order of price, and accepts bids sequentially starting from the lowest price until the amount of power (e.g., required) to meet the power demand predictive value is supplied. The third processing unit 113 may select a point at which supply and demand match, and determine a price of the final accepted bid as the system marginal price. The determined price may represent the cost of supplying final unit power to the power system at a specific time slot. The third processing unit 113 may set the combined cost of the cost of purchasing power for charging after the charging/discharging control and the cost of selling power through the discharging as an objective function using a system marginal price predictive value, and may minimize the difference value through an optimization process of the set objective function.

The third processing unit 113 may perform the optimization of the objective function by applying a gradient descent method, a steepest descent method, or a stochastic gradient descent method.

The fourth processing unit 114 may adjust the second charging/discharging schedule to reflect the battery deterioration cost of the electric vehicle.

The fourth processing unit 114 may adjust the second charging/discharging schedule so that the total cost of the electric vehicle battery deterioration cost is minimized for each time slot of a plurality of time slots. The lifespan of the electric vehicle battery may be (e.g., largely) determined by two factors. One factor is the number of charging-discharging cycles, and the other factor is a charging-discharging ratio. That is, as the number of charging-discharging cycles and the number of times charging and discharging repeatedly increase, the lifespan of the electric vehicle battery becomes shorter. This is because the battery undergoes slight deterioration each time it is charged and discharged. Typically, when the number of charging-discharging cycles reaches 1,000 to 2,000, battery performance drops to 80% or more.

Therefore, the fourth processing unit 114 may adjust the second charging/discharging schedule by taking into account the battery deterioration cost.

The fourth processing unit 114 may calculate a charging/discharging schedule that minimizes the combined cost of the energy cost and the battery deterioration cost by adjusting the second charging/discharging schedule calculated under the condition of following the target SoC and the contracted power capacity.

The fourth processing unit 114 may adjust the second charging/discharging schedule so that the battery deterioration cost of the electric vehicle is minimized. The fourth processing unit 114 may adjust the second charging/discharging schedule so that the continuity of the charging/discharging operation is maintained in successive first and second charging/discharging commands. As described above, battery deterioration may be affected by the number of times the charging/discharging are repeated. Accordingly, the fourth processing unit 114 may adjust the second charging/discharging schedule so that a charging state and a discharging state may be maintained as much as possible in order to minimize the number of times the battery is charged and discharged.

The fourth processing unit 114 may calculate a weight according to the types of charging/discharging actions in the first charging/discharging command and the second charging/discharging command, and may adjust the second charging/discharging schedule according to the weight. In an embodiment, the charging/discharging command may include a charging command or a discharging command, a charging amount, or a discharging amount in a specific time slot. The first charging/discharging command may mean a charging/discharging command at a time slot t−1, and the second charging/discharging command may mean a charging/discharging command at a time t.

The weight may have a specific value, and may have a positive or negative value. A weight having a positive value is a value calculated when the charging/discharging actions are continuous, and may mean a compensation weight. A negative weight is a value calculated when the charging/discharging actions are not continuous, and may mean a penalty weight.

In this description, a weight having a positive value has the same meaning as the compensation weight, and an inverse weight having a negative value may be used with the same meaning as the penalty weight.

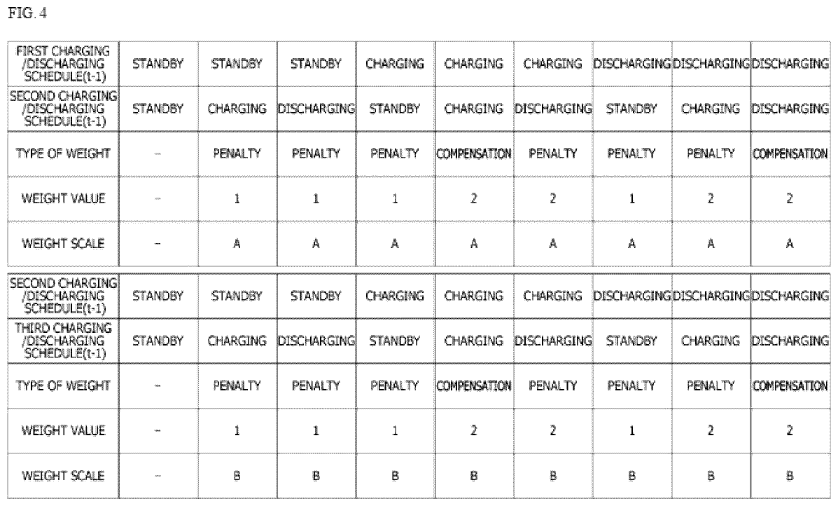

FIGS. 4 to 7 are views for describing the operation of the fourth processing unit 114 according to an example embodiment.

Referring to FIG. 4, the weight may have different weight scales for each time slot. The fourth processing unit 114 may set the weight scales differently for each period. For example, when a weight scale in a first period (t−1 to t) is A and a weight scale in a second period (t to t+1) is B, the fourth processing unit 114 may multiply the weight value of the first period by the value A and may multiply the weight value of the second period by the value B to calculate a final weight.

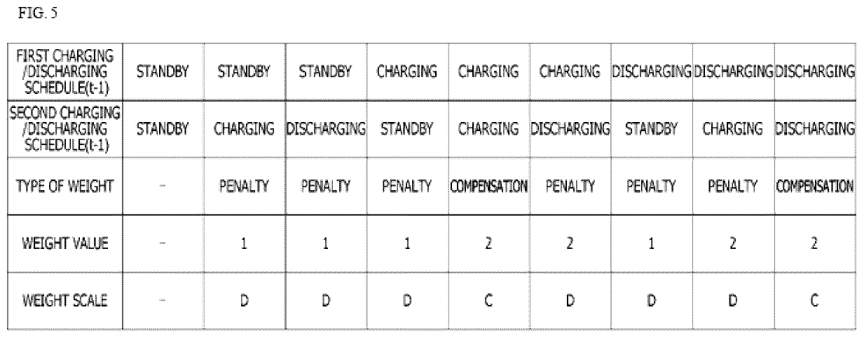

Referring to FIG. 5, the fourth processing unit 114 may set the first weight scale for the compensation weight and the second weight scale for the penalty weight differently. The weight scale may mean a multiplier by which the value of the calculated weight is multiplied.

For example, the fourth processing unit 114 may calculate the first weight scale in the first period (t−1 to t) as C and the second weight scale as D. The fourth processing unit 114 may calculate the final weight by multiplying the compensation weight value calculated for the first period by the value C, or by multiplying the penalty weight value calculated for the first period by the value D.

Additionally, the fourth processing unit 114 may set different weight scales according to the types of charging/discharging actions.

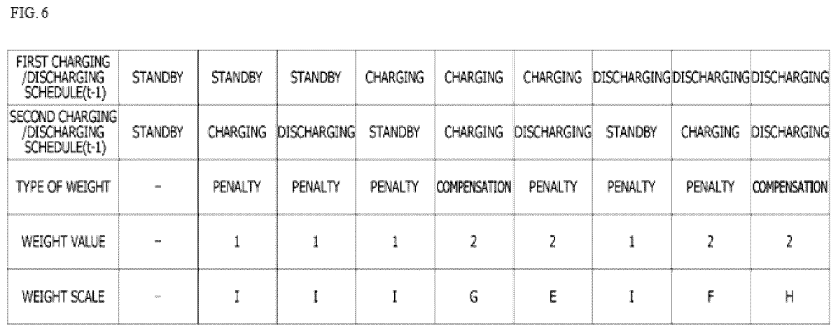

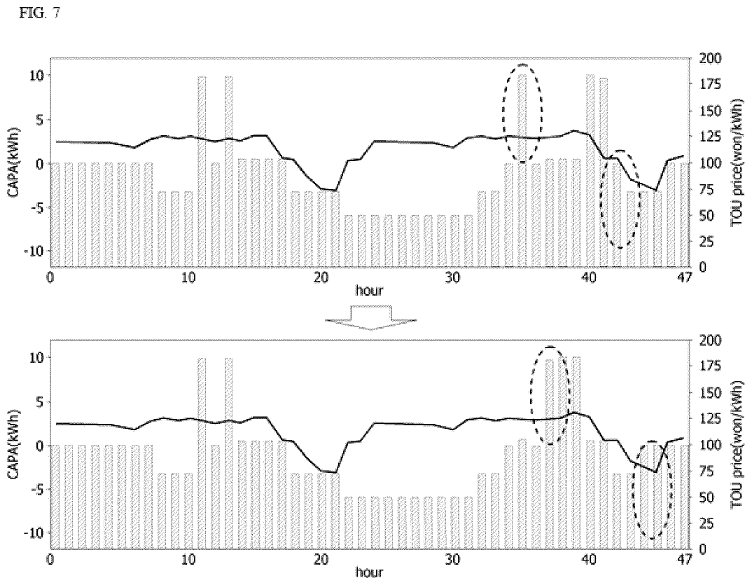

Referring to FIG. 6, the fourth processing unit 114 may set the weight scale to E when the charging/discharging action of the first time slot is charging and the charging/discharging action of the second time slot is discharging, and may set the weight scale to F when the charging/discharging action of the first time slot is discharging and the charging/discharging action of the second time slot is charging. Also, the fourth processing unit 114 may set the weight scale to G when the charging/discharging action of the first time slot is charging and the charging/discharging action of the second time slot is charging, and may set the weight scale to H when the charging/discharging action of the first time slot is discharging and the charging/discharging action of the second time slot is discharging. Additionally, the fourth processing unit 114 may set the weight scale to I when a standby action is included.

Accordingly, the fourth processing unit 114 may calculate the final weight by multiplying the calculated penalty weight by the weight scale E when the first charging/discharging command and the second charging/discharging command are charging-discharging.

Alternatively, the fourth processing unit 114 may calculate the final weight by multiplying the calculated penalty weight by the weight scale F when the first charging/discharging command and the second charging/discharging command are discharging-charging.

Alternatively, the fourth processing unit 114 may calculate the final weight by multiplying the calculated penalty weight by the weight scale G when the first charging/discharging command and the second charging/discharging command are charging-charging.

Alternatively, the fourth processing unit 114 may calculate the final weight by multiplying the calculated penalty weight by the weight scale H when the first charging/discharging command and the second charging/discharging command are discharging-discharging.

The fourth processing unit 114 may set the weight scale using the target SoC and contracted power capacity data. The fourth processing unit 114 may set the weight scale for each time slot according to at least one of the cost of selling power for each time slot, the cost of purchasing power, and the electric vehicle charging rate system.

For example, when the cost of purchasing power for each time slot is high, the fourth processing unit 114 may set the compensation weight for a charging/discharging command having discharging-discharging actions relatively high. Thus, when the cost of purchasing power is high, it is possible to maximize profits by encouraging the sale of power instead of purchasing power.

For example, when the cost of selling power for each time slot is high, the fourth processing unit 114 may set the compensation weight for a charging/discharging command having charging-charging actions relatively low. Thus, when the cost of selling power is high, it is possible to maximize profits by encouraging the sale of power instead of purchasing power.

In this way, the fourth processing unit 114 may adjust the second charging/discharging schedule to maximize profits by setting different weight scales according to the cost of selling power for each time slot, the cost of purchasing power, and the electric vehicle charging rate system, even for the same charging/discharging actions.

The fourth processing unit 114 may adjust the second charging/discharging schedule by reflecting a first inverse weight when the charging/discharging actions in the first charging/discharging command and the second charging/discharging command are different.

For example, the fourth processing unit 114 may calculate an inverse weight having a negative weight when the charging/discharging action in the first charging/discharging command is charging and the charging/discharging action in the second charging/discharging command is discharging.

For example, the fourth processing unit 114 may calculate an inverse weight having a negative weight value when the charging/discharging action in the first charging/discharging command is discharging and the charging/discharging action in the second charging/discharging command is charging.

The fourth processing unit 114 may adjust the second charging/discharging schedule by reflecting a second inverse weight that is smaller than the first inverse weight when one of the first charging/discharging command and the second charging/discharging command is a standby command. The second inverse weight may be determined as a value within a range of 30 to 70% of the first inverse weight. When the charging/discharging command is switched from a standby state to a charging or discharging state, or switched from a discharging (or charging) state to a standby state, the fourth processing unit 114 may set the inverse weight value to be relatively smaller when it is switched from the charging (or discharging) state to the discharging (or charging) state. That is, the fourth processing unit 114 may set the weight value to be small when switching between the standby state and the charging/discharging state compared to when switching between the charging/discharging states, which have a relatively large effect on battery deterioration. Thus, instead of the switching between the charging/discharging states, the switching between the standby state and the charging/discharging states may be induced.

The fourth processing unit 114 may adjust the second charging/discharging schedule by reflecting the weight when the charging/discharging actions in the first charging/discharging command and the second charging/discharging command are the same.

For example, the fourth processing unit 114 may calculate a compensation weight having a positive weight value when the charging/discharging action in the first charging/discharging command is charging and the charging/discharging action in the second charging/discharging command is charging.

For example, the fourth processing unit 114 may calculate a compensation weight having a positive weight value when the charging/discharging action in the first charging/discharging command is discharging and the charging/discharging action in the second charging/discharging command is discharging.

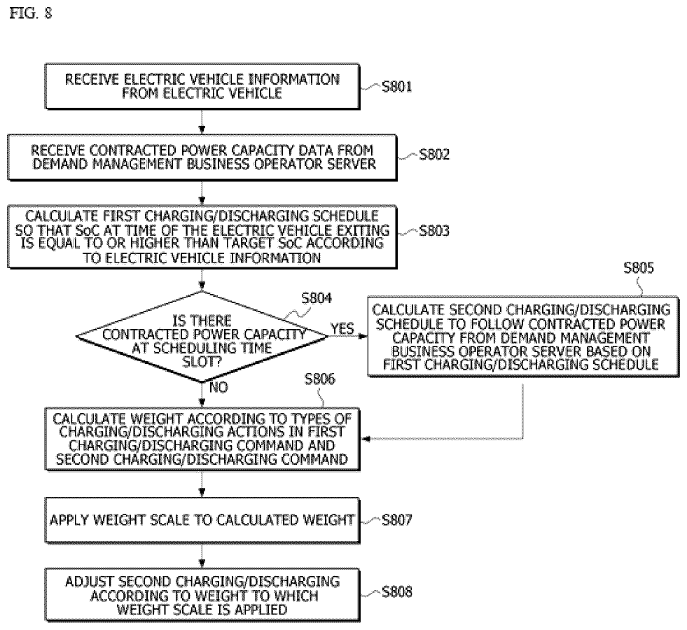

Referring to FIG. 7, it may be confirmed that the fourth processing unit 114 has adjusted the second charging/discharging schedule to continuously maintain the charging action by changing the charging action planned at 34 (an upper graph) hours before the second charging/discharging schedule is adjusted to 37 hours (a lower graph). At this time, it may be confirmed that the fourth processing unit 114 has adjusted the second charging/discharging schedule under a condition of the second charging/discharging schedule designed to follow the target SoC and comply with the contracted power capacity.

The electric vehicle charging/discharging scheduling apparatus 100 according to the example embodiment may independently perform various functions using a plurality of objective functions and constraint functions.

For example, the electric vehicle charging/discharging scheduling apparatus 100 may calculate a charging/discharging schedule according to an objective function that maximizes profits in the process of charging, discharging, and following the contracted power capacity. In this process, the processor 110 may set the following of the target SoC as the top priority objective function to calculate the first charging/discharging schedule, and secondarily set the objective function to satisfy the contracted power capacity to calculate the second charging/discharging schedule. The processor 110 may reflect the total profit of the profit from power sales (e.g., discharging) and the cost of purchasing power (e.g., charging) in the second charging/discharging schedule so that the total profit may be maximized using the system marginal price predictive value under the condition that the target SoC and the contracted power capacity are followed.

The processor 110 may calculate the first charging/discharging schedule so that the SoC is adjusted to within the battery usage range as a (e.g., top) priority when the SoC of the electric vehicle is outside the battery usage range.

In addition, the processor 110 may manage to prevent SoC loss from occurring during the power transaction process by finally calculating the second charging/discharging schedule so that the sum of the charging efficiency and the sum of the discharging efficiency are the same.

The processor 110 may calculate the first charging/discharging schedule to follow the target SoC set for each of the vehicle exit times when there are multiple vehicle entry times and vehicle exit times, and may calculate the second charging/discharging schedule to comply with a specified contracted power capacity for each time slot. In addition, when there are multiple vehicle entry times and vehicle exit times, the processor 110 may reflect the profit from power sales (e.g., discharging) and the cost of purchasing power (e.g., charging) during a total scheduling target period in the second charging/discharging schedule so that the overall profit may be maximized.

Additionally, the processor 110 may adjust the second charging/discharging schedule so that the charging/discharging action of the electric vehicle may be maintained as continuously as possible. The processor 110 may apply the compensation weight when the continuous charging/discharging actions are the same, and may apply the penalty weight when the continuous charging/discharging actions are different. The compensation weight may have a positive value, and the penalty weight may have a negative value. The processor 110 may adjust the second charging/discharging schedule so that the compensation weight and the penalty weight have maximum values in the second charging/discharging schedule.

That is, the processor 110 sets the cost that is the sum of a battery SoC compliance condition of the electric vehicle, a contracted power capacity compliance and profit maximization condition, and a maintenance condition of the continuous charging/discharging action as the objective function, and may minimize a difference value through the optimization process of the set objective function.

The processor 110 may perform optimization of the objective function by applying a gradient descent method, a steepest descent method, or a stochastic gradient descent method.

Thus, reliability may be improved by satisfying the battery SoC of the electric vehicle which is the top priority on the V2X platform, while complying with the contracted power capacity in the power transaction market as a secondary goal. Additionally, it is possible to maximize profits or minimize expenses from power sales and purchases in a situation in which (e.g., all) the priority goals are met. In addition, the charging/discharging schedule may be adjusted to minimize battery deterioration under a condition in which the battery SoC of the electric vehicle and contracted power capacity are followed and profits are maximized, and thus the charging/discharging schedule may be finally calculated.

FIG. 8 is a flowchart of an electric vehicle charging/discharging scheduling method according to an embodiment.

First, a communication means receives electric vehicle information from an electric vehicle. The electric vehicle information includes plug-in charger information, present SoC, target SoC, source type information, battery capacity information, and expected vehicle entry time and expected vehicle exit time information (S801).

Next, the communication means receives the contracted power capacity data from the demand management business operator server (S802).

Next, the processor calculates the first charging/discharging schedule so that the SoC at the time the electric vehicle exits is equal to or higher than the target SoC according to the electric vehicle information (S803).

Next, the processor determines whether there is a contracted power capacity in a scheduling time slot in the contracted power capacity data (S804).

Next, when there is a contracted power capacity, the processor calculates the second charging/discharging schedule to follow the contracted power capacity from the demand management business operator server based on the first charging/discharging schedule (S805).

When there is no contracted power capacity, the first charging/discharging schedule is used as the second charging/discharging schedule, and the next step is performed.

Next, the processor calculates a weight according to the types of charging/discharging actions in the first charging/discharging command and the second charging/discharging command (S806).

Next, the processor applies a weight scale to the calculated weight (S807).

Next, the processor adjusts the second charging/discharging schedule according to the weight to which the weight scale is applied (S808).

The term “˜unit” used in this embodiment may be software or hardware components such as a field-programmable gate array (FPGA) or ASIC, and the “˜unit” may perform certain roles. However, the “˜unit” is not limited to software or hardware. The “˜unit” may be configured to reside on an addressable storage medium or may be configured to cause one or more processors to be regenerated. Thus, as an example, the “˜unit” includes components such as software components, object-oriented software components, class components, and task components, and processes, functions, attributes, procedures, subroutines, segments of program code, drivers, firmware, microcode, circuits, data, databases, data structures, tables, arrays, and variables. Functionality provided within the components and “˜units” may be combined into a smaller number of components and “˜units” or further separated into additional components and “˜units.” Additionally, the components and “˜units” may be implemented to reproduce one or more CPUs in a device or secure multimedia card.

An electric vehicle charging/discharging scheduling apparatus and method according to an embodiment may perform optimal electric vehicle charging/discharging scheduling.

In addition, battery deterioration costs of an electric vehicle may be minimized and the life of batteries may be extended.

Additionally, profits by participating in a power trading market using the power of an electric vehicle may be generated.

Although the present disclosure has been described above with reference to example embodiments thereof, it may be understood that various modifications and changes may be made to the present disclosure without departing from the spirit and scope of the present disclosure as set forth herein.

What is claimed is:

1. An electric vehicle charging and discharging scheduling apparatus for an electric vehicle, comprising:
a memory storing computer-executable instructions; and
at least one processor configured to access the memory and execute the instructions, wherein the instructions comprise:
calculating a first charging and discharging schedule wherein a state of charge (SoC) at a time of the electric vehicle exiting a charging station is equal to or higher than a target SoC according to electric vehicle information;
calculating a second charging and discharging schedule for participation in a power market according to contracted power capacity data received from a demand management business operator server based on the first charging and discharging schedule;
adjusting the second charging and discharging schedule of the electric vehicle to reflect battery deterioration cost of the electric vehicle; and
generating and outputting a charging and discharging control command based on the adjusted second charging and discharging schedule.

2. The apparatus of claim 1, wherein the instructions of the processor further comprise adjusting the second charging and discharging schedule to minimize the battery deterioration cost of the electric vehicle.

3. The apparatus of claim 2, wherein the instructions of the processor further comprise adjusting the second charging and discharging schedule to maintain continuity of charging and discharging actions in successive first and second charging and discharging commands.

4. The apparatus of claim 3, wherein instructions of the processor further comprise calculating a weight according to a plurality of charging and discharging actions in the first charging and discharging command and the second charging and discharging command, and adjusting the second charging and discharging schedule according to the weight.

5. The apparatus of claim 4, wherein instructions of the processor further comprise adjusting the second charging and discharging schedule by reflecting a first inverse weight when the charging and discharging actions in the first charging and discharging command and the second charging and discharging command are different.

6. The apparatus of claim 5, wherein the instructions of the processor further comprise adjusting the second charging and discharging schedule by reflecting a second inverse weight that is smaller than the first inverse weight when at least one of the first charging and discharging command and the second charging and discharging command is a standby command.

7. The apparatus of claim 4, wherein the instructions of the processor further comprise adjusting the second charging and discharging schedule by reflecting a weight when the charging and discharging actions in the first charging and discharging command and the second charging and discharging command are the same.

8. The apparatus of claim 4, wherein the weight has a different weight scale for each time slot of a plurality of time slots.

9. The apparatus of claim 8, wherein the instructions of the processor further comprise setting the weight scale using the target SoC and the contracted power capacity data.

10. The apparatus of claim 9, wherein instructions of the processor further comprise setting the weight scale for each time slot of the plurality of time slots according to at least one of cost of selling power for each time slot of the plurality of time slots, cost of purchasing power, and a charging rate system of the electric vehicle.

11. An electric vehicle charging and discharging scheduling method comprising:
providing a computing device including a memory storing computer-executable instructions and at least one processor configured to access the memory and execute the instructions, wherein the instructions comprise:
calculating, by the processor, a first charging and discharging schedule wherein a state of charge (SoC) at a time of the electric vehicle exiting a charging station is equal to or higher than a target SoC according to electric vehicle information;
calculating, by the processor, a second charging and discharging schedule for participation in a power market according to contracted power capacity data received from a demand management business operator server based on the first charging and discharging schedule;
adjusting, by the processor, the second charging and discharging schedule of the electric vehicle to reflect battery deterioration cost of the electric vehicle; and
generating and outputting a charging and discharging control command based on the adjusted second charging and discharging schedule.

12. The method of claim 11, wherein the adjusting of the second charging and discharging schedule includes adjusting the second charging and discharging schedule to minimize the battery deterioration cost of the electric vehicle.

13. The method of claim 12, wherein the adjusting of the second charging and discharging schedule includes adjusting the second charging and discharging schedule to maintain continuity of charging and discharging actions in successive first and second charging and discharging commands.

14. The method of claim 13, wherein the adjusting of the second charging and discharging schedule includes:
calculating a weight according to types of charging and discharging actions in the first charging and discharging command and the second charging and discharging command; and
adjusting the second charging and discharging schedule according to the weight.

15. The method of claim 14, wherein the adjusting of the second charging and discharging schedule includes adjusting the second charging and discharging schedule by reflecting a first inverse weight when the charging and discharging actions in the first charging and discharging command and the second charging and discharging command are different.

16. The method of claim 15, wherein the adjusting of the second charging and discharging schedule includes adjusting the second charging and discharging schedule by reflecting a second inverse weight that is smaller than the first inverse weight when at least one of the first charging and discharging command and the second charging and discharging command is a standby command.

17. The method of claim 14, wherein the adjusting of the second charging and discharging schedule includes adjusting the second charging and discharging schedule by reflecting a weight when the charging and discharging actions in the first charging and discharging command and the second charging and discharging command are the same.

18. The method of claim 14, wherein the weight has different weight scales for each time slot of a plurality of time slots.

19. The method of claim 18, wherein the adjusting of the second charging and discharging schedule further includes setting the weight scale using the target SoC and the contracted power capacity data.

20. The method of claim 19, wherein the setting of the weight scale includes setting the weight scale according to at least one of cost of selling power for each time slot of the plurality of time slots, cost of purchasing power, and a charging rate system of the electric vehicle.
